(19) United States
(12) Patent Application Publication
(10) Pub. No.: US 2008/0071593 A1
(43) Pub. Date: Mar. 20, 2008

(54) Business process editor, business process editing method, and computer product

(75) Inventors: Yuka Tanaka, Kawasaki (JP); Kyoko Ohashi, Kawasaki (JP); Rieko Yamamoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/708,118

(22) Filed: Feb. 16, 2007

(30) Foreign Application Priority Data
Sep. 19, 2006 (JP) 2006-253215

(51) Int. Cl. G06F 9/44

(52) U.S. Cl. 705/7

(57) ABSTRACT

A business process editor includes a business-system analysis-result reader and a business process editing unit. The business-system analysis-result reader reads a result of analysis of specification of electronic processing performed by a business system. The business process editing unit edits a data structure that represents business process diagram, in which a business object corresponding to a business process includes, among information read by the business-system analysis-result reader, information related to electronic processing performed in the business process.

### BACKGROUND OF THE INVENTION

1. Field of the Invention

The present invention relates to a technology for editing a business process diagram that represents a flow of business process including electronic processing performed by a business system.

2. Description of the Related Art

A specification, which describes details of various programs, data formats etc. is important for maintenance of a business system that operates in an information processor. During construction of an information processing system, sufficient time is allocated to create the specification. However, in many cases, the specification is not revised according to a correction of the business system or a modification of the specification. Due to this, content that does not match the actually operating business system increases with the passage of time.

A technology that analyzes the business system to automatically generate the specification enables to easily obtain the specification with the content that completely matches the actually operating business system.

For example, with a technology disclosed in Japanese Patent Application Laid-open No. 2005-122407 to analyze a batch job description language, the specification related to programs for the batch jobs, and input and output of the programs can be obtained. Besides, by analyzing a screen definition field, the specification related to screen type programs can be obtained.

However, the specification obtained by using the conventional technology is a list of programs and data, and is difficult to comprehend for a person other than a system engineer who thoroughly comprehends a design and development operation of the business system.

For example, implementing large scale business improvement including the business system necessitates a discussion with a person in a utilization division using information materials related to a process flow and a structure of the business system. However, the person in the utilization division is not a system engineer and is not able to comprehend the specification obtained by using the conventional technology.

Comprehensibly visualizing a business process including the business system as a business process diagram is effective for anyone who is not well versed in a data processing technology to easily comprehend the structure of the business system and the process flow.

### SUMMARY OF THE INVENTION

It is an object of the present invention to at least partially solve the problems in the conventional technology.

According to an aspect of the present invention, a business process editor that edits a business process diagram that represent a flow of business process including electronic processing performed by a business system, includes a reading unit that reads a result of analysis of specification of the electronic processing, and an editing unit that edits a data structure that represents the business process diagram, in which a business object corresponding to a business process includes, among information read by the reading unit, information related to electronic processing performed in the business process.

According to another aspect of the present invention, a business process editing method for electronically editing a business process diagram that represents a flow of business process including electronic processing performed by a business system, includes reading a result of analysis of specification of the electronic processing, and editing a data structure that represents the business process diagram, in which a business object corresponding to a business process includes, among information read at the reading, information related to electronic processing performed in the business process.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION. OF THE DRAWINGS

FIG. 1 is a functional block diagram of a business process editor according to an embodiment of the present invention;

FIG. 2 is an example of a job analysis result;

FIG. 3 is an example of batch-program analysis result;

FIG. 4 is an example of job-program related analysis result;

FIG. 5 is an example of screen-program analysis result;

FIG. 6 is an example of a business data object;

FIG. 7 is an example of a screen object;

FIG. 8 is an example of a business process editing screen after a business process is created;

FIG. 9 is an example of a screen-search screen;

FIG. 10 is an example of a screen list;

FIG. 11 is an example of a business-process-name input screen;

FIG. 12 is an example of the business process editing screen after addition of a business process;

FIG. 13 is a schematic of a data structure for displaying a business process diagram shown in FIG. 12;

FIG. 14 is details of a system supported process object shown in FIG. 13;

FIG. 15 is details of a system process object shown in FIG. 13;

FIG. 16 is an example of the business process editing screen after a business process is created;

FIG. 17 is an example of a job search screen;

FIG. 18 is an example of a job list screen;

FIG. 19 is an example of an input/output data select screen;

FIG. 20 is an example of the business process editing screen after addition of a business process;

FIG. 21 is a schematic of a data structure for displaying the business process diagram shown in FIG. 20;

FIG. 22 is details of a job system process object shown in FIG. 21;

FIG. 23 is an example of a completed business process diagram;

FIG. 24 is a flowchart of the operation of an unused-resource output unit shown in FIG. 1;

FIG. 25 is a detailed flowchart of an unused-job output process shown in FIG. 24;

FIG. 26 is a detailed flowchart of an unused batch-program output process shown in FIG. 24;

FIG. 27 is a detailed flowchart of an unused screen-program output process shown in FIG. 24;

FIG. 28 is an example of contents of an unused resource list;

FIG. 29 is a flowchart of the operation of a target-resource output unit shown in FIG. 1;

FIG. 30 is an example of resource data;

FIG. 31 is a flowchart of the operation of an affected process output unit shown in FIG. 1;

FIG. 32 is an example of a modification select screen;

FIGS. 33 and 34 are examples of output of the affected process output unit; and

FIG. 35 is a functional block diagram of a computer that executes a business process editing program.

### DETAILED DESCRIPTION OF THE PREFERRED EMBODIMENTS

Exemplary embodiments of the present invention are explained below with reference to the accompanying drawings.

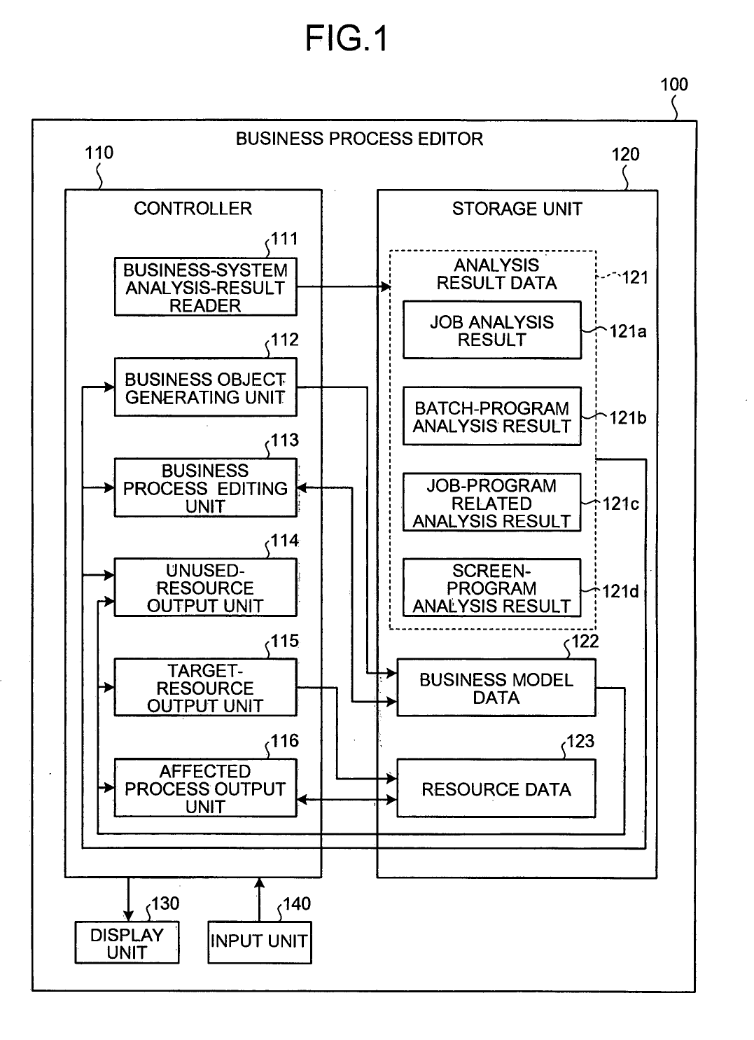

FIG. 1 is a functional block diagram of a business process editor 100 according to an embodiment of the present invention. The business process editor 100 includes a controller 110, a storage unit 120, a display unit 130, and an input unit 140. Examples of the display unit 130 include a Liquid Crystal Display (LCD). Examples of the input unit 140 include a keyboard and a mouse.

The controller 110 entirely controls the business process editor 100. The controller 110 includes a business-system analysis-result reader 111, a business object generating unit 112, a business process editing unit 113, an unused-resource output unit 114, a target-resource output unit 115, and an affected process output unit 116.

The business-system analysis-result reader 111 reads an output result of a program (for example, a specification generating program disclosed in Japanese Patent Application Laid-open No. 2005-122407) that generates specification data by analyzing a batch job description language of an existing business system, and stores the read output result in the storage unit 120 as analysis result data 121.

The business object generating unit 112 reads the analysis result data 121 to generate business objects and stores the generated business objects in the storage unit 120 as business model data 122. The business objects are data that represents each business process in a business process diagram.

The business process editing unit 113 causes the display unit 130 to display a business process editing screen. The business process editing unit 113 carries out generation, deletion, and establishing a correspondence of the business objects according to an input from the input unit 140, and outputs the business process diagram corresponding to a formed data structure to the business process editing screen or to a not shown printing device connected to the business process editor 100. The business process editing unit 113 also carries out a process to store the formed data structure as the business model data 122 and a process to read the data structure from the business model data 122.

Further, the business process editing unit 113 causes the display unit 130 to display various support screens for embedding in the business process diagram, the business objects that are generated by the business object generating unit 112. The business process editing unit 113 sets, in attributes of the business objects that are embedded in the support screens or correspond to the support screens, the data of jobs and programs that are executed by the business processes represented by the business objects.

Thus, the business process editor 100 can read the analysis result of the existing business system to generate the business objects, and embed the generated business objects in the business process diagram by a simple operation. Due to this, a user can easily edit the business process diagram that accurately reflects a content of the existing business system.

The unused-resource output unit 114 compares the data read by the business-system analysis-result reader 111 and stored as the analysis result data 121 with the data structure of the business process diagram created by the business process editing unit 113 and stored as the business model data 122. The unused-resource output unit 114 extracts data that is not reflected in the business process diagram and outputs the extracted data as a list.

Thus, the business process editor 100 outputs the list of the data that is not reflected in the business process diagram from the data read by the business-system analysis-result reader 111. Due to this, the user can avoid occurrence of a reflection omission when reflecting the content of the existing business system in the business process diagram.

When modifying a business process with the aim of business improvement, the target-resource output unit 115 and the affected process output unit 116 support an operation to confirm portions of the current business system that are affected.

To be specific, the target-resource output unit 115 extracts the jobs and the programs that are set in the attributes of the business objects corresponding to the specified business process, and stores the extracted jobs and the programs in the storage unit 120 as resource data 123 of a modification target. Due to this, when modifying the business process, the user can know the jobs and the programs that may need to be reconfigured.

Further, the affected process output unit 116 extracts and outputs the business process that executes a job or a program selected as a modification target from jobs and programs included in the resource data 123. Due to this, if the jobs and the programs that need to be modified are also being used for other business, the user can know the other business.

Thus, based on the data structure of the created business process diagram, the business process editor 100 extracts programs that need to be modified along with modification of the business process. Due to this, when considering business improvement, the user can easily know the portions of the business system and the other business processes that are affected due to the modification of the business process.

Further, by clarifying a correspondence between the modification of the business processes and the modification of the business system, the user can easily maintain the business process diagram such that the content of the business system continues to be accurately reflected in the business process diagram.

The storage unit 120 stores therein various types of data. The storage unit 120 stores therein the analysis result data 121, the business model data 122, and the resource data 123. The analysis result data 121 represents the analysis result of the existing business system and includes a job analysis result 121a, a batch-program analysis result 121b, a job-program related analysis result 121c, and a screen-program analysis result 121d.

The job analysis result 121a is a list of the jobs. The batch-program analysis result 121b is data that represents a correspondence between batch programs and input output data of the batch programs. The job-program related analysis result 121c is data that represents a correspondence between the jobs and the batch programs included in the jobs. The screen-program analysis result 121d is data that represents a correspondence between screens and screen programs.

The business model data 122 is data that includes data of the individual business objects included in the business process diagram and the data structure that represents the correspondence of the business objects. The resource data 123 is list data of the programs that necessitate modification when modifying the specified business process in the business process diagram.

Next, an operation of each unit of the controller 110 is explained in detail. The business-system analysis-result reader 111 reads the output result of the programs that analyze the existing business system to generate the specification data, and stores the read output result in the storage unit 120 as the job analysis result 121a, the batch-program analysis result 121b, the job-program related analysis result 121c, and the screen-program analysis result 121d.

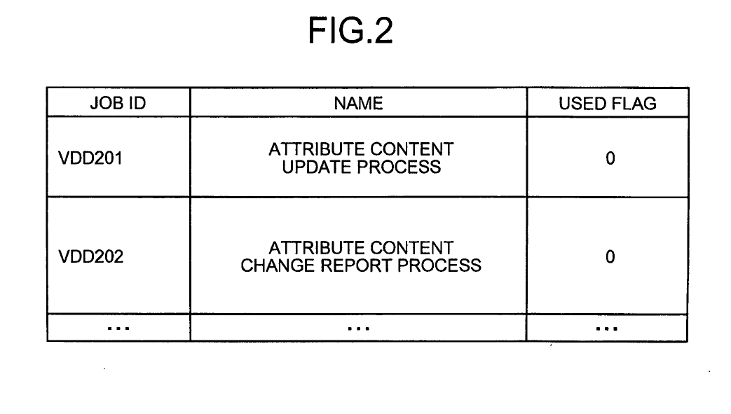

FIG. 2 is an example of the job analysis result 121a. The job analysis result 121a includes items such as job identification (ID), name, and used flag. A record of the job analysis result 121a is registered with respect to each job. The job ID is an identification code for identifying each job. The name is a name of the job. The used flag is a flag value that indicates whether the job is reflected in the business process diagram. The business-system analysis-result reader 111 initially sets the used flag to “0”.

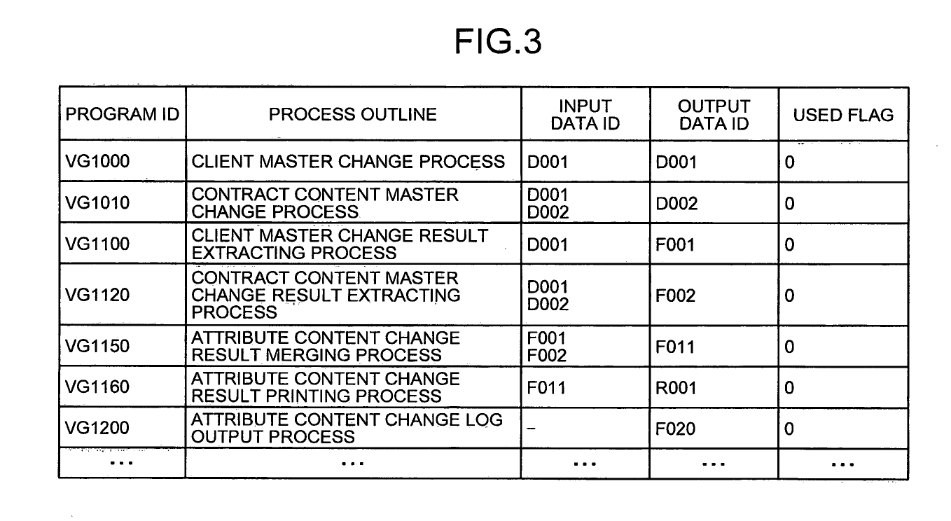

FIG. 3 is an example of the batch-program analysis result 121b. The batch-program analysis result 121b includes items such as program ID, process outline, input data ID, output data ID, and used flag. A record of the batch-program analysis result 121b is registered with respect to each batch program. The program ID is an identification code for identifying each batch program. The process outline is a character string that represents the process outline of the batch program.

The input data ID is a list of identification codes of data input to the batch program. The output data ID is a list of identification codes of data output from the batch program. If no data exists that is input to the batch program, the entry of the input data is not set. If no data exists that is output from the batch program, the entry of the output data is not set. The used flag is a flag value that indicates whether the batch program is reflected in the business process diagram. The business-system analysis-result reader 111 initially sets the used flag to “0”.

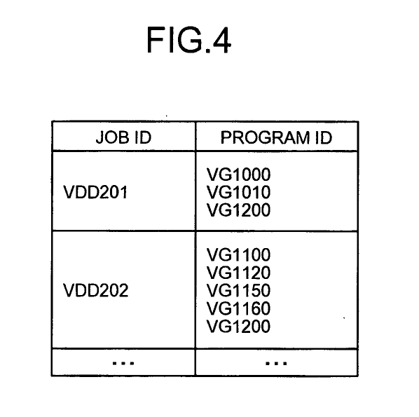

FIG. 4 is an example of the job-program related analysis result 121c. The job-program related analysis result 121c includes items such as job ID and program ID. A record of the job-program related analysis result 121c is registered with respect to each job. The job ID is an identification code for identifying the job. The program ID is a list of identification codes for identifying batch programs involved in the job.

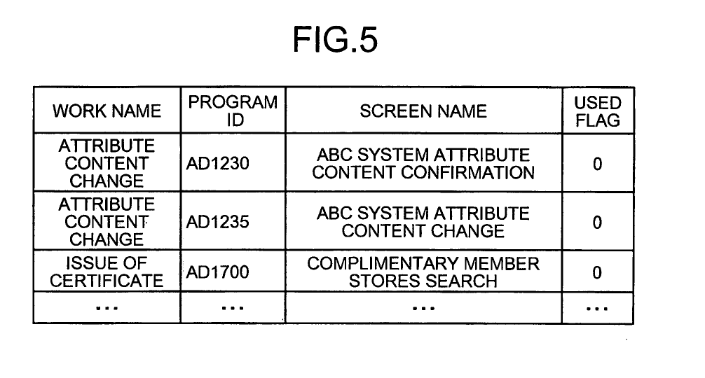

FIG. 5 is an example of the screen-program analysis result 121d. The screen-program analysis result 121d includes items such as work name, program ID, screen name, and used flag. A record of the screen-program analysis result 121d is registered with respect to each screen program. The work name indicates names of business categories of multiple screens including a screen on which the screen program is executed. The program ID is an identification code for identifying the screen program.

The screen name is the name of the screen on which the screen program is executed. The used flag is a flag value that indicates whether the screen program is reflected in the business process diagram. The business-system analysis-result reader 111 initially sets the used flag to “0”.

An operation of the business object generating unit 112 is explained next. Based on the batch-program analysis result 121b etc. stored in the storage unit 120 by the business-system analysis-result reader 111, the business object generating unit 112 generates the business objects. To be specific, the business object generating unit 112 reads each record of the batch-program analysis result 121b and generates the business objects corresponding to data ID that are stored in the entries of the input data ID and the output data ID.

For example, upon reading a record of the batch-program analysis result 121b in the first row of FIG. 3, the business object generating unit 112 fetches an identification code “D001” that is set as the input data ID, and generates the business object with a name “D001”.

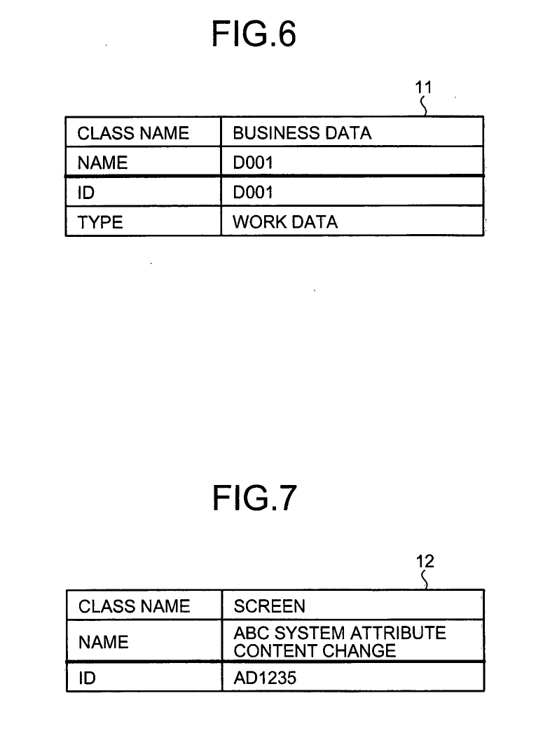

FIG. 6 is an example of a business data object 11 generated based on the fetched record. The business data object 11 is identified by a combination of class name: “business data” and name: “D001”.

Further, the business object has attribute data corresponding to the class name. The attribute data of the business data object 11 includes a combination of attribute name: “ID” and attribute value: “D001” and a combination of attribute name: “type” and attribute value: “business data”. The attribute corresponding to “type” can be changed to “file”, “slip”, or “database” etc. by an editing function of the business process editing unit 113.

The business object generating unit 112 reads all the records of the batch-program analysis result 121b and generates the business data objects corresponding to all the input output data related to the batch programs.

The business object generating unit 112 reads all the records of the screen-program analysis result 121d and, based on the content of the records, generates screen objects that are a type of the business objects. FIG. 7 is an example of a screen object 12 generated upon reading the record of the screen-program analysis result 121d in the second row of FIG. 5.

The screen object 12 has a class name “screen” and a name “ABC system attribute content change”. The screen object 12 has attribute data including a combination of attribute name: “ID” and attribute value: “AD1235”.

An operation of the business process editing unit 113 is explained next. The business process editing unit 113 causes the display unit 130 to display the business process editing screen, causes the user to edit the business process diagram, maintains and reads the data structure corresponding to an editing result, and causes the display unit 130 to display the support screens for embedding in the business process diagram the business objects that are generated by the business object generating unit 112. The support screens that are displayed due to the operation of the business process editing unit 113 are explained with reference to specific examples.

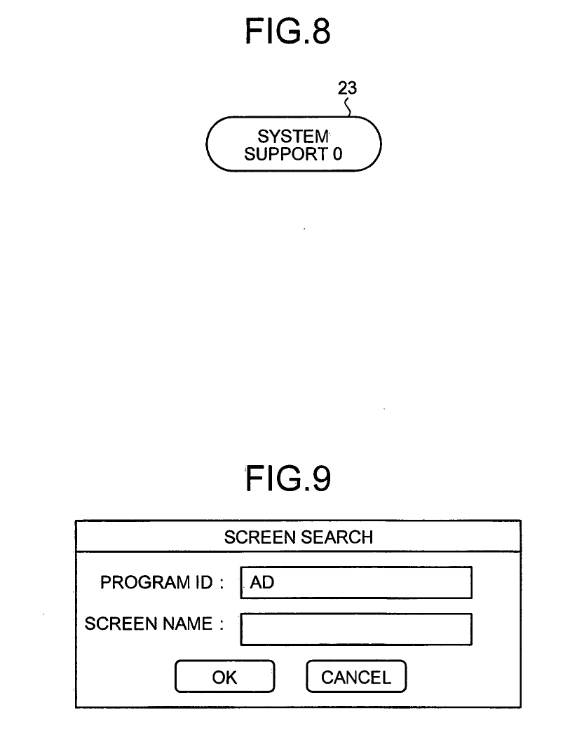

FIG. 8 is an example of the business process editing screen after the business process is created. In the example of FIG. 8, the user has performed a predetermined operation on the business process editing screen to create a business process 23 with a name “system support 0”. Upon creation of the business process 23 on the business process editing screen, the business process editing unit 113 generates the business object corresponding to the business process 23.

Upon the user carrying out the predetermined operation on the business process editing screen by selecting the business process 23, the business process editing unit 113 displays a screen-search screen that is a type of the support screen. FIG. 9 is an example of the screen-search screen. The screen-search screen indicates items to input a program ID and a screen name as conditions for narrowing screen programs to be displayed in a list.

Upon the user inputting the conditions in the screen-search screen and pressing an OK button, the business process editing unit 113 extracts from all the screen objects, the screen objects that match the input conditions, and displays data of the extracted screen objects in a screen list that is a type of the support screen.

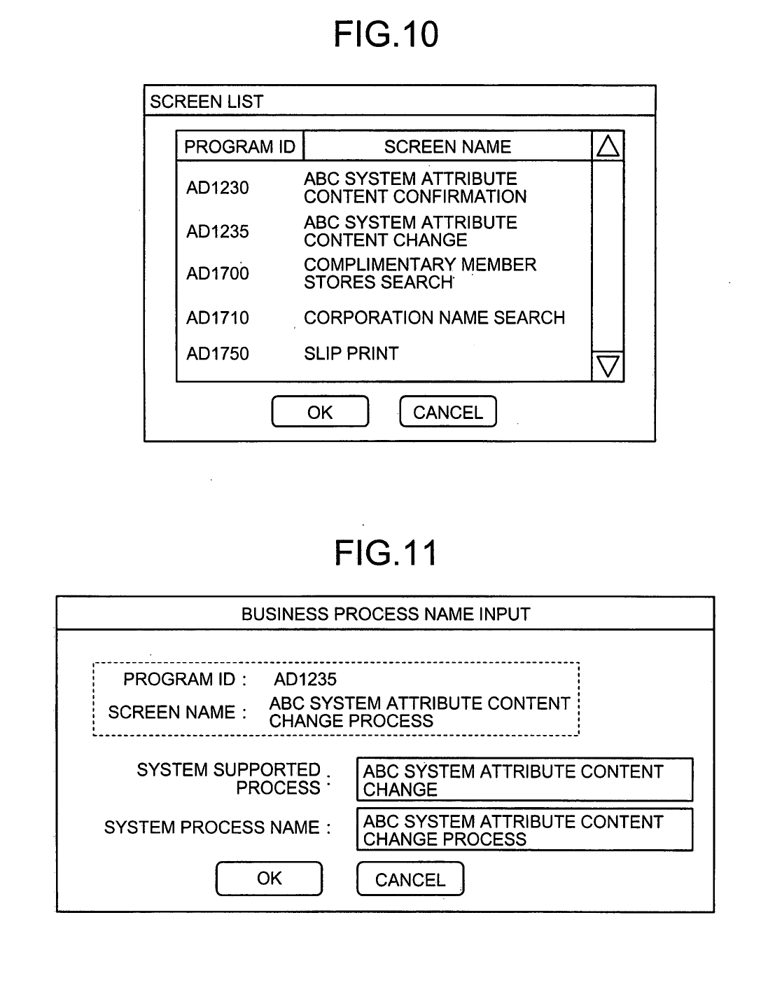

FIG. 10 is an example of the screen list. The screen list is displayed after the user inputs “AD” as the program ID on the screen-search screen and presses the OK button. Upon input of “AD” as the program ID on the screen-search screen, the business process editing unit 113 extracts screen objects including a character string “AD” in the attribute value corresponding to the attribute name “ID”, and lists data of the extracted screen objects in the screen list.

When the user selects data corresponding to a specific screen object and presses the OK button, the business process editing unit 113 displays a business-process-name input screen that is a type of the support screen. It is assumed herein that the user selects data with a program ID “AD1235” and a screen name “ABC system attribute content change”.

FIG. 11 is an example of the business-process-name input screen. As shown in FIG. 11, the business-process-name input screen includes an area that displays data for checking the content selected from the screen list in the upper portion and an area for inputting a system supported process name and a system process name in the lower portion.

The system supported process name is a name of the business process that is supported by the screen program corresponding to the screen object selected from the screen list. The business process editing unit 113 sets as an initial value in the input item of the system supported process name, the screen name selected from the screen list. The system process name is a name of the business process processed by the screen program corresponding to the screen object selected from the screen list. The business process editing unit 113 sets as an initial value in the input item of the system process name, a process name by adding the character string “process” to the screen name selected from the screen list.

Upon the user changing, if required, the values of the input entries of the system supported process name and the system process name at the business-process-name input screen and pressing the OK button, the business process editing unit 113 displays on the business process editing screen a graphic element corresponding to the screen object selected from the screen list, and associates the graphic element with the business process selected when displaying the screen-search screen. Further, the business process editing unit 113 displays in the business process editing screen the business process having the name input as the system process name on the business-process-name input screen and associates the business process selected when displaying the screen-search screen with the graphic element corresponding to the screen object selected from the screen list.

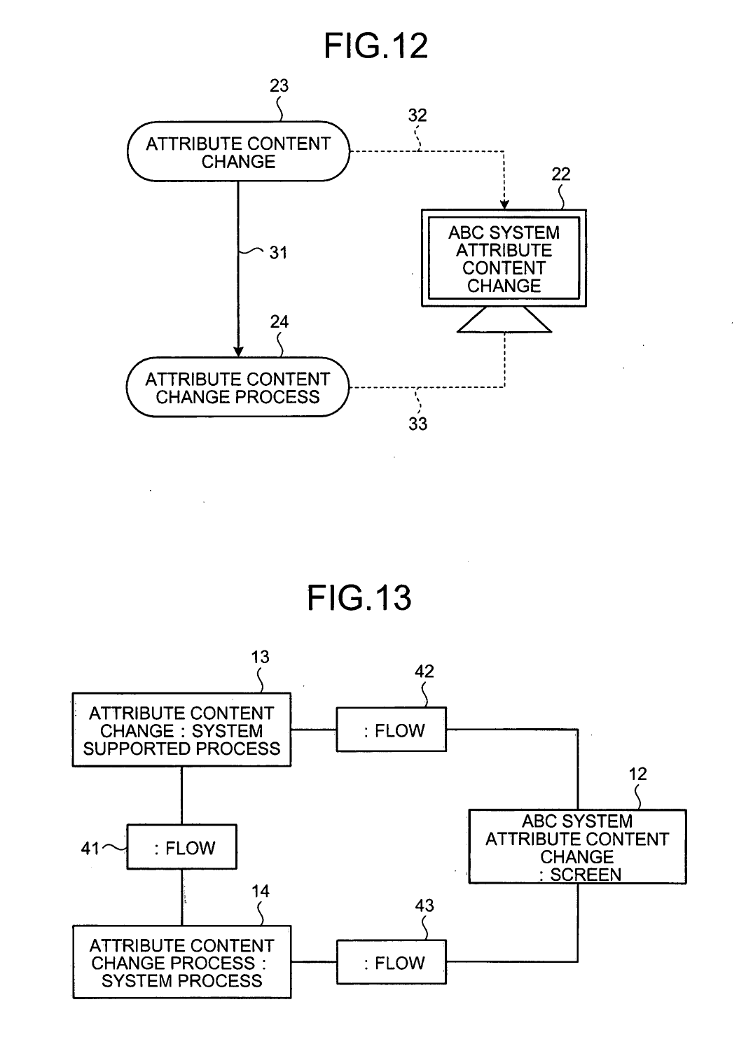

FIG. 12 is an example of the business process editing screen after the user changes, on the business-process-name input screen, the system supported process name to “attribute content change” and the system process name to “attribute content change process”, and presses the OK button. As shown in FIG. 12, in addition to the business process 23 with a name “attribute content change”, a business process 24 with a name “attribute content change process” is also included in the business process editing screen.

The business process editing screen also includes a graphic element 22 corresponding to the screen object selected from the screen list. The graphic element 22 is in the form of a monitor for indicating the correspondence with the screen object and has a name “ABC system attribute content change”. An arrow 31 that indicates a transition establishes a correspondence between the business process 23 and the business process 24. An arrow 32 that indicates input output establishes a correspondence between the business process 23 and the graphic element 22. An arrow 33 that indicates input output establishes a correspondence between the business process 24 and the graphic element 22.

Thus, the business process editing unit 113 embeds in the business process diagram the graphic element (the graphic element 22 in the example of FIG. 12) corresponding to the screen object generated by the business object generating unit 112 and supports the operation to establish a correspondence between the business process (the business process 24 in the example of FIG. 12) processed by the screen program corresponding to the screen object and the business process (the business process 23 in the example of FIG. 12) supported by the screen program.

FIG. 13 is a schematic of the data structure for displaying the business process diagram shown in FIG. 12. After the user has pressed the OK button at the business-process-name input screen, the business process editing unit 113 converts to a system supported process object 13 a business process object with a name “system supported 0”, and changes the name to “attribute content change”. The business process editing unit 113 newly generates a system process object 14 with a name “attribute content change process”.

The system supported process object 13 is the business object corresponding to the business process 23 in the business process diagram shown in FIG. 12. The system process object 14 is the business object corresponding to the business process 24 in the business process diagram shown in FIG. 12.

The business process editing unit 113 generates a flow object 41 that represents a transition, and establishes a correspondence between the system supported process object 13 and the system process object 14. The flow object 41 is an object corresponding to the arrow 31 in the business process diagram shown in FIG. 12.

Further, the business process editing unit 113 generates a flow object 42 that represents input output and establishes a correspondence between the system supported process object 13 and the screen object 12 generated by the business object generating unit 112. The business process editing unit 113 generates a flow object 43 that represents input output and establishes a correspondence between the system process object 14 and the screen object 12. The flow object 42 is an object corresponding to the arrow 32 in the business process diagram shown in FIG. 12. The flow object 43 is an object corresponding to the arrow 33.

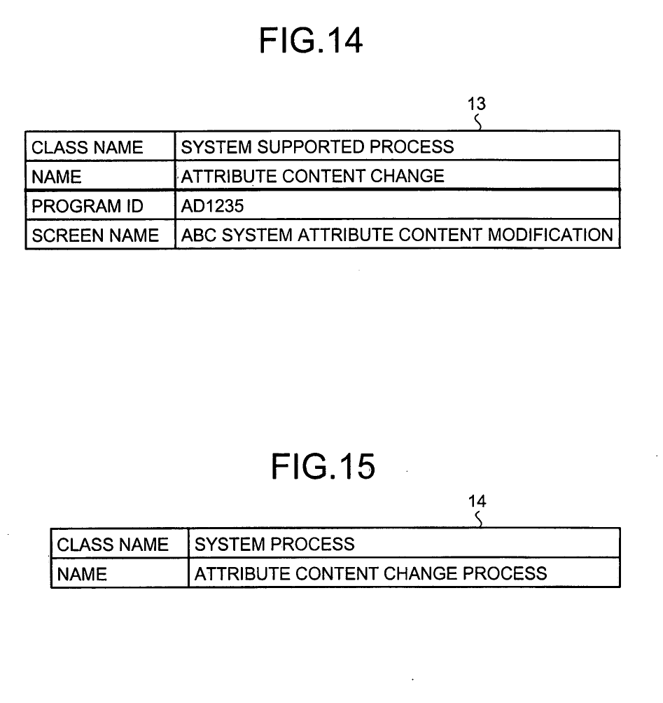

FIG. 14 is details of the system supported process object 13 shown in FIG. 13. As shown in FIG. 14, the system supported process object 13 has a class name “system supported process” and a name “attribute content change”. Further, for indicating the supported screen program, the system supported process object 13 has attribute data including a combination of attribute name: “program ID” and attribute value: “AD1235”, and a combination of attribute name: “screen name” and attribute value: “ABC system attribute content change”.

FIG. 15 is details of the system process object 14 shown in FIG. 13. As shown in FIG. 15, the system process object 14 has a class name “system process” and a name “attribute content change process”.

Apart from supporting the operation to embed the screen objects in the business process diagram, the business process editing unit 113 also supports an operation to embed the business data objects in the business process diagram. Support screens which are displayed by the business process editing unit 113 for easily carrying out embedding of the business data objects are explained next with reference to specific examples.

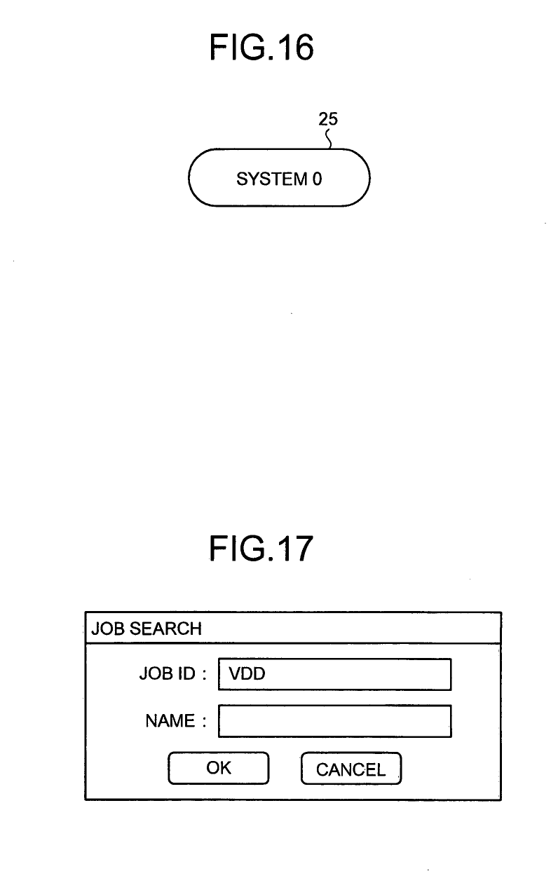

FIG. 16 is an example of the business process editing screen after the business process is created. In the example of FIG. 16, the user has performed a predetermined operation on the business process editing screen to create a business process 25 having a name “system 0”. Upon creation of the business process 25 at the business process editing screen, the business process editing unit 113 generates the business object corresponding to the business process 25.

When the user selects the business process 25 and performs the predetermined operation on the business process editing screen, the business process editing unit 113 displays a job search screen that is a type of the support screen. FIG. 17 is an example of the job search screen. The job search screen indicates items to input a job ID and a job name as conditions for narrowing jobs to be displayed in a list.

Upon the user inputting the conditions to the job search screen and pressing the OK button, the business process editing unit 113 extracts from the job analysis result 121a the job that matches with the input conditions and displays data of the extracted job in a job list screen that is a type of the support screen.

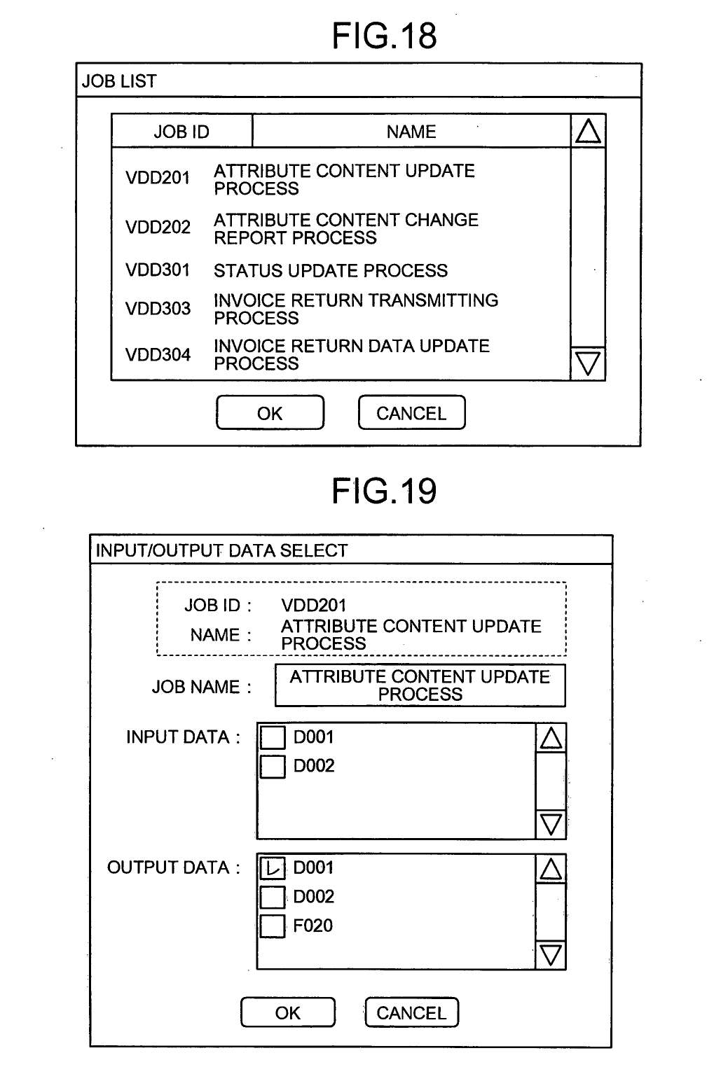

FIG. 18 is an example of the job list screen. The job list screen shown in FIG. 18 is displayed when the user inputs “VDD” as the job ID on the job search screen and presses the OK button. Upon input of “VDD” as the job ID on the job search screen, the business process editing unit 113 extracts from the job analysis result 121a records that include a character string “VDD” and lists data of the extracted records on the job list screen.

Upon the user selecting data related to a specific job on the job list screen and pressing the OK button, the business process editing unit 113 displays an input/output data select screen that is a type of the support screen. It is herein assumed that the user has selected data with a job ID “VDD201” and a name “attribute content update process”.

FIG. 19 is an example of the input/output data select screen. As shown in FIG. 19, the input/output data select screen includes an area that displays data for checking the content selected on the job list screen in the upper portion and an area for changing the job name and selecting input data and output data in the lower portion.

The business process editing unit 113 fetches from the job-program related analysis result 121c a list of the program ID of the batch programs included in the job selected on the job list screen. The business process editing unit 113 refers to the batch-program analysis result 121b and displays in the input/output data select screen, a list of the business data objects corresponding to the input data and a list of the business data objects corresponding to the output data of the batch programs included in the fetched list.

Upon assuming that the user selects the job with a job ID “VDD201” on the job list screen, the business process editing unit 113 fetches from the job-program related analysis result 121c a list that includes three program IDs “VG1000”, “VG1010”, and “VG1200”.

Next, the business process editing unit 113 refers to the batch-program analysis result 121b, fetches “D001” and “D002” as the data ID of the input data of the batch programs having the fetched program ID, and displays in the input/output data select screen, data of the business data objects corresponding to the fetched data ID as selected candidates of the input data.

Similarly, the business process editing unit 113 refers to the batch-program analysis result 121b, fetches “D001”, “D002”, and “F020” as the data ID of the output data of the batch programs having the fetched program ID, and displays in the input/output data select screen, data of the business data objects corresponding to the fetched data ID as selected candidates of the output data.

Upon the user selecting, if required, the selected candidates of the input data and the output data at the input/output data select screen and pressing the OK button, the business process editing unit 113 displays in the business process editing screen the graphic element corresponding to the selected business data object, and establishes a correspondence between the graphic element and the business process selected when displaying the job search screen.

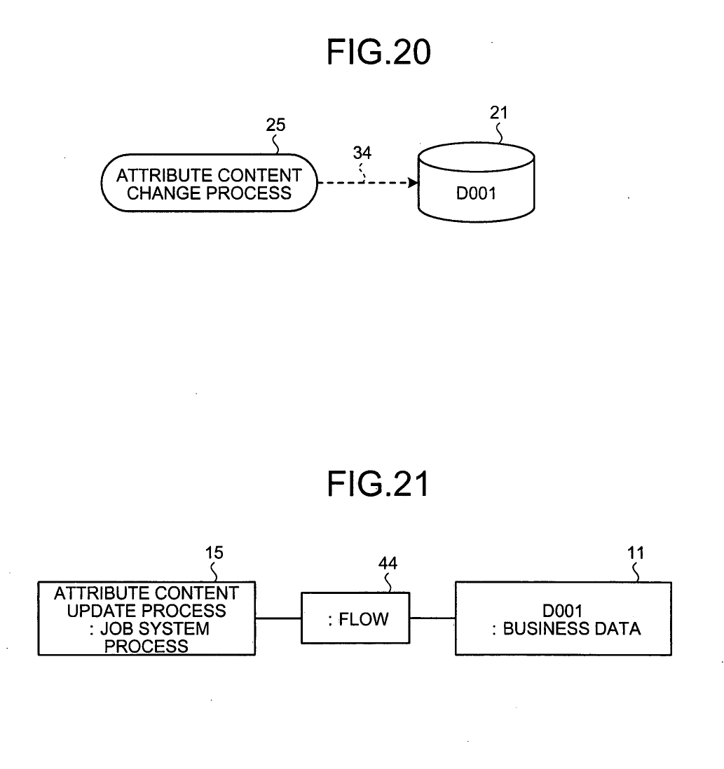

FIG. 20 is an example of the business process editing screen after the user changes the job name to “attribute content update process” in the input/output data select screen shown in FIG. 19, selects the business data object with a data ID “D001” from the selected candidates of the output data, and presses the OK button. As shown in FIG. 20, in addition to the business process 25 having the name “attribute content change process”, a graphic element 21 corresponding to the business data object selected at the input/output data select screen is also included in the business process editing screen.

The graphic element 21 indicates the correspondence with the business data object and has a name “D001”. An arrow 34 that indicates input output establishes a correspondence between the business process 25 and the graphic element 21. In the example shown in FIG. 20, only one graphic element corresponding to the business data object is added. However, if multiple business data objects are selected at the input/output data select screen, an equal number of the graphic elements are added.

Thus, the business process editing unit 113 embeds in the business process diagram the graphic element (the graphic element 21 in the example of FIG. 20) corresponding to the business data object generated by the business object generating unit 112, and supports the operation to establish a correspondence between the graphic element and the business process (the business process 25 in the example of FIG. 20) processed by the job that inputs and outputs data corresponding to the business data object.

FIG. 21 is a schematic of the data structure for displaying the business process diagram shown in FIG. 20. Upon the user pressing the OK button on the input/output data select screen, the business process editing unit 113 changes the business process object with a name “system 0” to a job system process object 15 with a name “attribute content update process”, generates a flow object 44 that represents input and output, and establishes a correspondence between the job system process object 15 and the business data object 11 generated by the business object generating unit 112. The flow object 44 is an object corresponding to the arrow 34 in the business process diagram shown in FIG. 20.

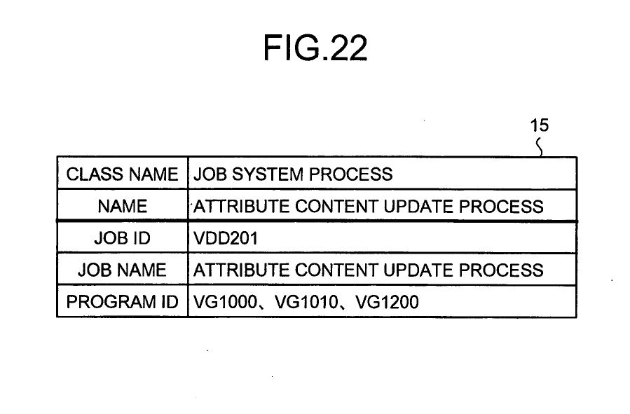

FIG. 22 is details of the job system process object 15 shown in FIG. 21. The job system process object 15 has a class name “job system process” and a name “attribute content update process”.

Further, for indicating the job for processing the business process and the batch programs included in the job, the job system process object 15 has attribute data including a combination of attribute name: “job ID” and attribute value: “VDD201”, a combination of attribute name: “job name” and attribute value: “attribute content update process”, and a combination of attribute name: “program ID” and attribute values: “VG1000, VG1010, and VG1200”.

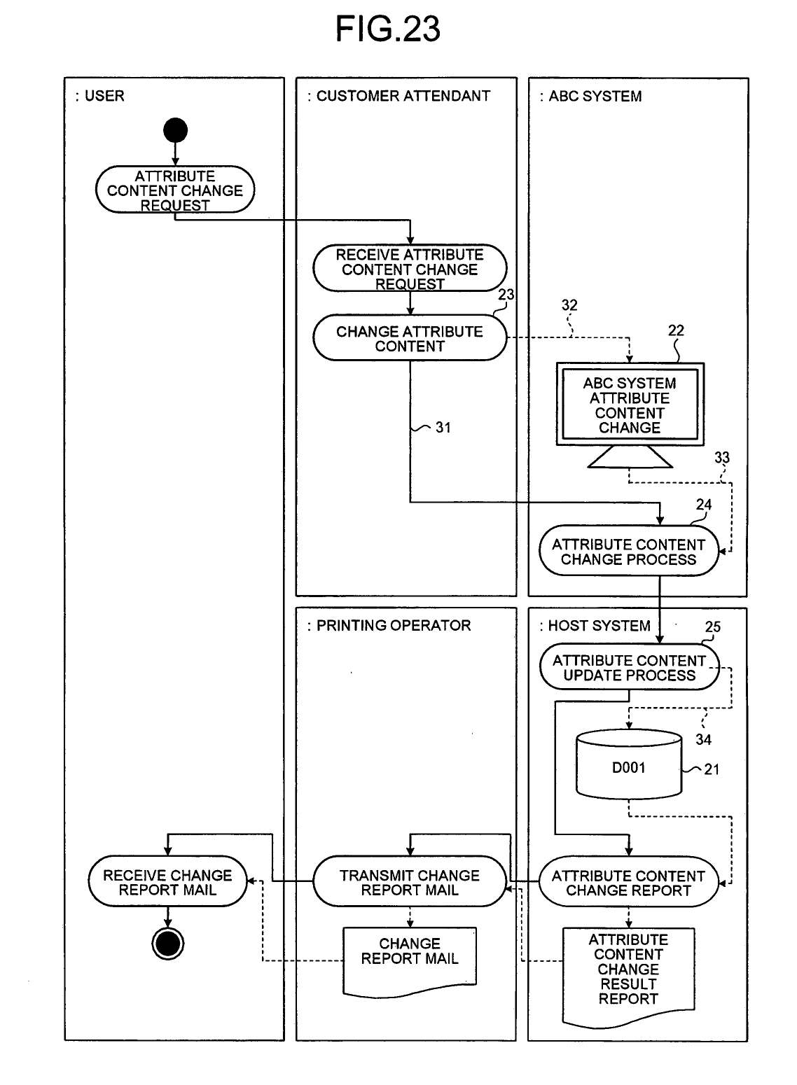

FIG. 23 is an example of the completed business process diagram. The business process diagram is created by using a support function of the business process editing unit 113 and includes the business process 23 shown in FIG. 12 and the business process 25 shown in FIG. 20.

An operation of the unused-resource output unit 114 is explained next. The unused-resource output unit 114 compares data stored as the analysis result data 121 with the data structure of the business process diagram created by the business process editing unit 113, extracts data that is not reflected in the business process diagram, and outputs a list of the extracted data.

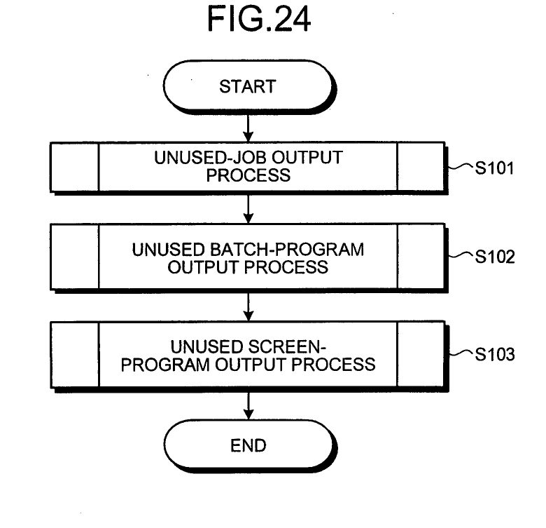

FIG. 24 is a flowchart of the operation of the unused-resource output unit 114. The unused-resource output unit 114 performs an unused-job output process to output data of jobs that have not been reflected in the business process diagram (step S101), performs an unused batch-program output process to output data of batch programs that have not been reflected in the business process diagram (step S102), and performs an unused screen-program output process to output data of screen programs that have not been reflected in the business process diagram (step S103).

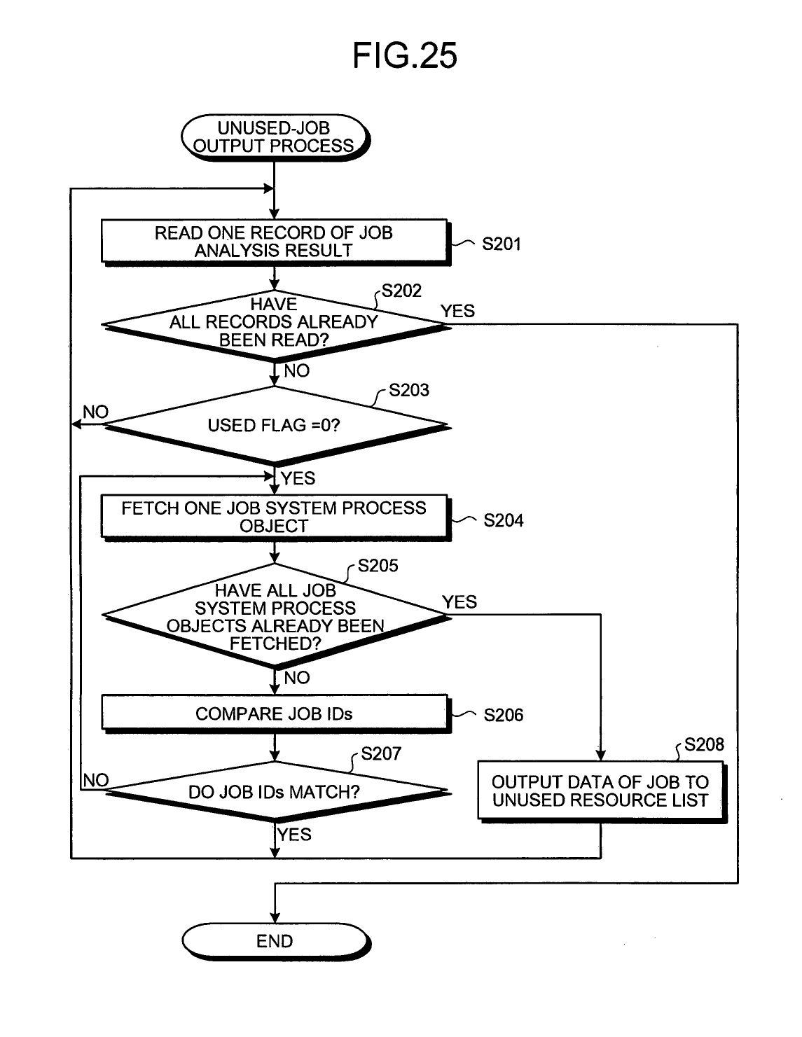

FIG. 25 is a detailed flowchart of the unused-job output process. The unused-resource output unit 114 reads one record from the job analysis result 121a (step S201). If all the records have already been read (Yes at step S202), the unused-resource output unit 114 ends the process.

Upon reading one record from the job analysis result 121a (No at step S202), the unused-resource output unit 114 checks the flag value of the used flag. If the flag value is not “0” (No at step S203), the process returns to step S201 and the unused-resource output unit 114 attempts to read the next record.

If the flag value is “0” (Yes at step S203), the unused-resource output unit 114 fetches one job system process object (step S204). If all the job system process objects have already been fetched (Yes at step S205), it is confirmed that a content of the record read at step S201 is not reflected in the business process diagram. After the unused-resource output unit 114 edits the data read at step S201 and outputs the edited data to an unused resource list (step S208), the process returns to step S201, and the unused-resource output unit 114 attempts to read the next record.

Upon fetching one job system process object (No at step S205), the unused-resource output unit 114 compares the job ID included in the record read at step S201 with the job ID included in the job system process object fetched at step S204 (step S206). If the two job IDs match (Yes at step S207), it is confirmed that the content of the record read at step S201 is reflected in the business process diagram. The process returns to step S201, and the unused-resource output unit 114 attempts to read the next record. If the two job IDs do not match (No at step S207), the process returns to step S204, and the unused-resource output unit 114 attempts to fetch the next job system process object.

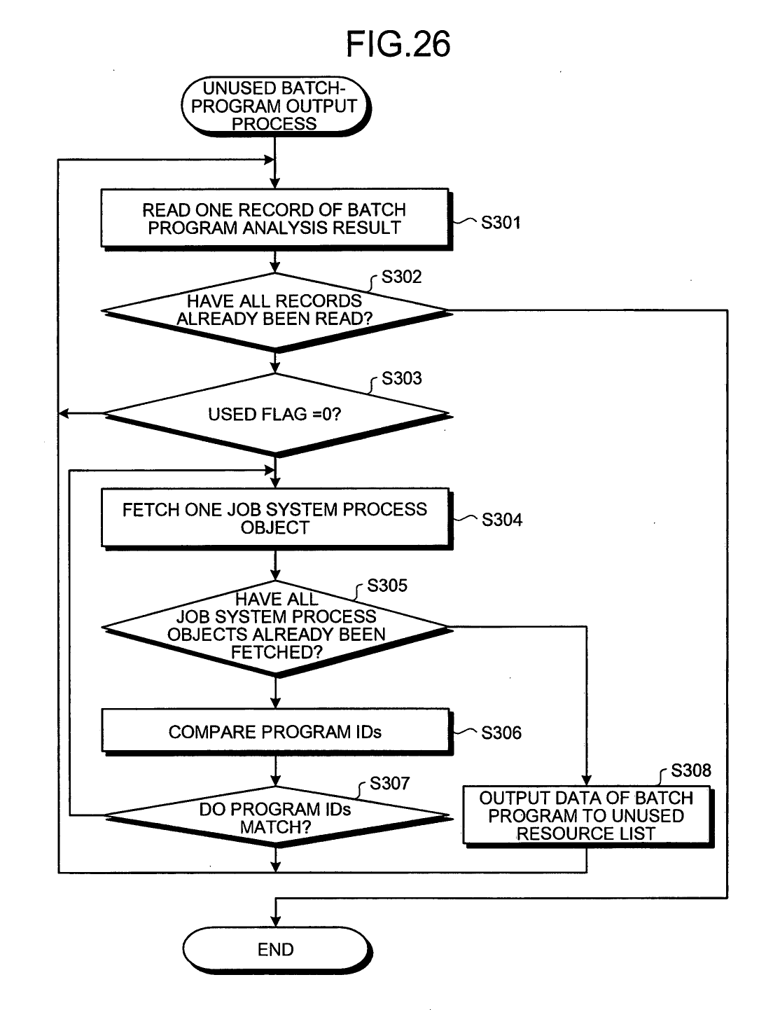

FIG. 26 is a detailed flowchart of the unused batch-program output process. The unused-resource output unit 114 reads one record from the batch-program analysis result 121b (step S301). If all the records have already been read (Yes at step S302), the unused-resource output unit 114 ends the process.

Upon reading one record from the batch-program analysis result 121b (No at step S302), the unused-resource output unit 114 checks the flag value of the used flag of the read record. If the flag value is not “0” (No at step S303), the process returns to step S301, and the unused-resource output unit 114 attempts to read the next record.

If the flag value of the used flag is “0” (Yes at step S303), the unused-resource output unit 114 fetches one job system process object (step S304). If all the job system process objects have already been fetched (Yes at step S305), it is confirmed that the content of the record read at step S301 is not reflected in the business process diagram. After the unused-resource output unit 114 edits the data read at step S301 and outputs the edited data to the unused resource list (step S308), the process returns to step S301, and the unused-resource output unit 114 attempts to read the next record.

Upon fetching one job system process object (No at step S305), the unused-resource output unit 114 compares the program ID included in the record read at step S301 with a list of the program IDs included in the job system process object fetched at step S304 (step S306). If the program ID included in the record read at step S301 is included in the list (Yes at step S307), it is confirmed that the content of the record read at step S301 is reflected in the business process diagram. The process returns to step S301, and the unused-resource output unit 114 attempts to read the next record. If the program ID is not included in the list (No at step S307), the process returns to step S304, and the unused-resource output unit 114 attempts to fetch the next job system process object.

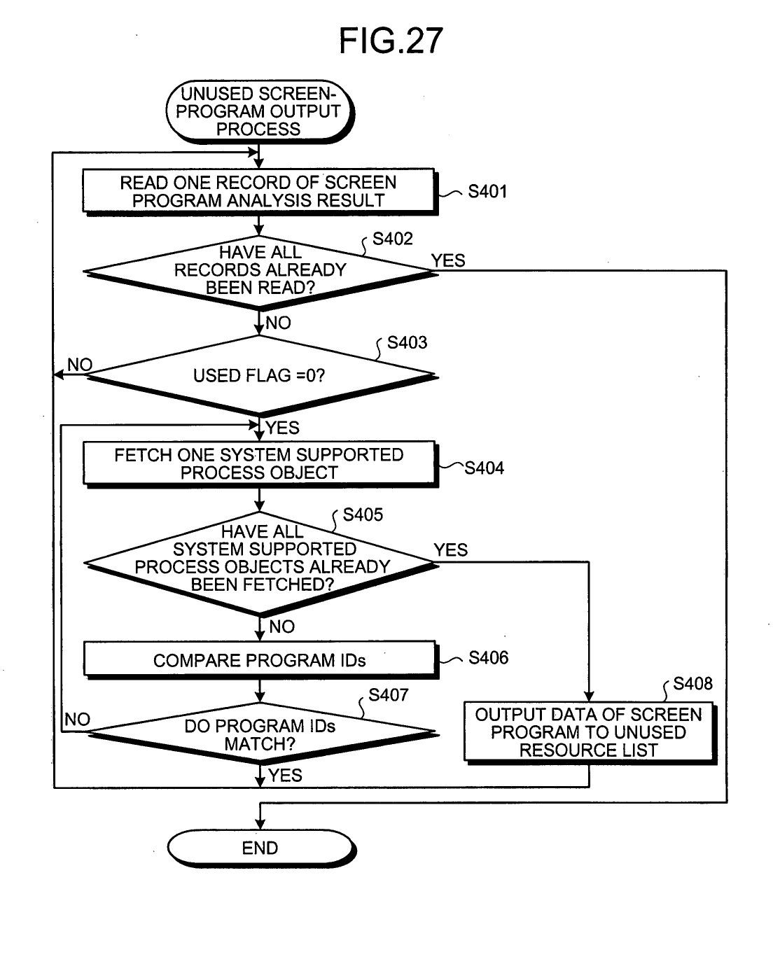

FIG. 27 is a detailed flowchart of the unused screen-program output process. The unused-resource output unit 114 reads one record from the screen-program analysis result 121d (step S401). If all the records have already been read (Yes at step S402), the unused-resource output unit 114 ends the process.

Upon reading one record from the screen-program analysis result 121d (No at step S402), the unused-resource output unit 114 checks the flag value of the used flag of the read record. If the flag value is not “0” (No at step S403), the process returns to step S401, and the unused-resource output unit 114 attempts to read the next record.

If the flag value is “0” (Yes at step S403), the unused-resource output unit 114 fetches one system supported process object (step S404). If all the system supported process objects have already been fetched (Yes at step S405), it is confirmed that the content of the record read at step S401 is not reflected in the business process diagram. After the unused-resource output unit 114 edits the data read at step S401 and outputs the edited data to the unused resource list (step S408), the process returns to step S401, and the unused-resource output unit 114 attempts to read the next record.

Upon fetching one system supported process object (No at step S405), the unused-resource output unit 114 compares the screen program ID included in the record read at step S401 with the screen program ID included in the system supported process object fetched at step S404 (step S406). If the two screen program IDs match (Yes at step S407), it is confirmed that the content of the record read at step S401 is reflected in the business process diagram. The process returns to step S401, and the unused-resource output unit 114 attempts to read the next record. If the two screen program IDs do not match (No at step S407), the process returns to step S404, and the unused-resource output unit 114 attempts to fetch the next system supported process object.

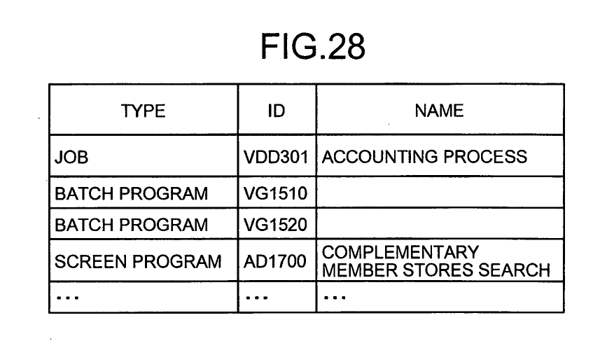

FIG. 28 is an example of contents of the unused resource list. The unused resource list includes items such as type, ID, and name, and stores therein data on jobs that are not reflected in the business process diagram and the like. During an output of the unused-job output process, the character string “job” is stored in the entry of type, the job ID is stored in the entry of ID, and the name of the job is stored in the entry of name.

During an output of the unused batch-program output process, the character string “batch program” is stored in the entry of type and the program ID is stored in the entry of ID. During an output of the unused screen-program output process, the character string “screen program” is stored in the entry of type, the program ID is stored in the entry of ID, and the name of the screen program is stored in the entry of name.

Referring to the unused resource list enables the user of the business process editor 100 to confirm the elements of the business system that the user has forgotten to reflect in the business process diagram and enables the user to reflect the content of the business system in the business process diagram without any omission. Such a function is especially effective when creating a large number of the business process diagram.

In the sequences of the aforementioned processes, a record is not output if the flag value of the used flag of the record is not “0”. This enables to prevent inclusion in the unused resource list of an element that is deliberately not reflected in the business process diagram due to reasons such as negligibility. However, the record in which the flag value of the used flag is not “0” can also be output to a separate list or can also be output by including the record in the unused resource list after displaying data to the effect that the record is used.

Further, the flag value of the used flag of the record that is not to be output can be changed to a value other than “0” manually or automatically by the business process editor 100 based on a rule.

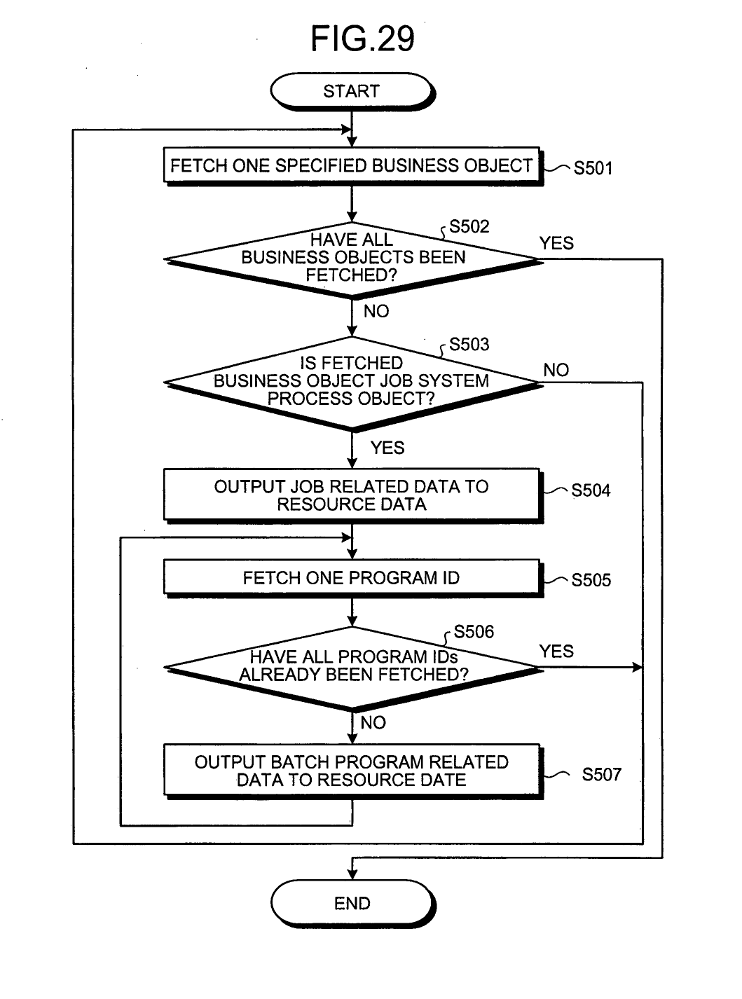

FIG. 29 is a flowchart of the operation of the target-resource output unit 115. The target-resource output unit 115 fetches one business object from the business objects that are specified as the business objects for modification (step S501). If all the specified business objects have already been fetched (Yes at step S502), the target-resource output unit 115 ends the process.

Upon fetching the specified business object (No at step S502), the target-resource output unit 115 checks the class name of the business object of the fetched record. If the class name is not “job system process” (No at step S503), the process returns to step S501, and the target-resource output unit 115 attempts to fetch the next business object.

If the class name is “job system process” (Yes at step S503), the target-resource output unit 115 outputs, to the resource data 123, job related data such as the job ID etc. that is set in the fetched business object (step S504).

Next, the target-resource output unit 115 fetches one program ID of the batch programs that is set in the business object (step S505). If all the program IDs have already been fetched (Yes at step S506), the process returns to step S501, and the target-resource output unit 115 attempts to fetch the next business object. Upon fetching the program ID (No at step S506), after the target-resource output unit 115 outputs batch program related data to the resource data 123 (step S507), the process returns to step S505, and the target-resource output unit 115 attempts to fetch the next program ID.

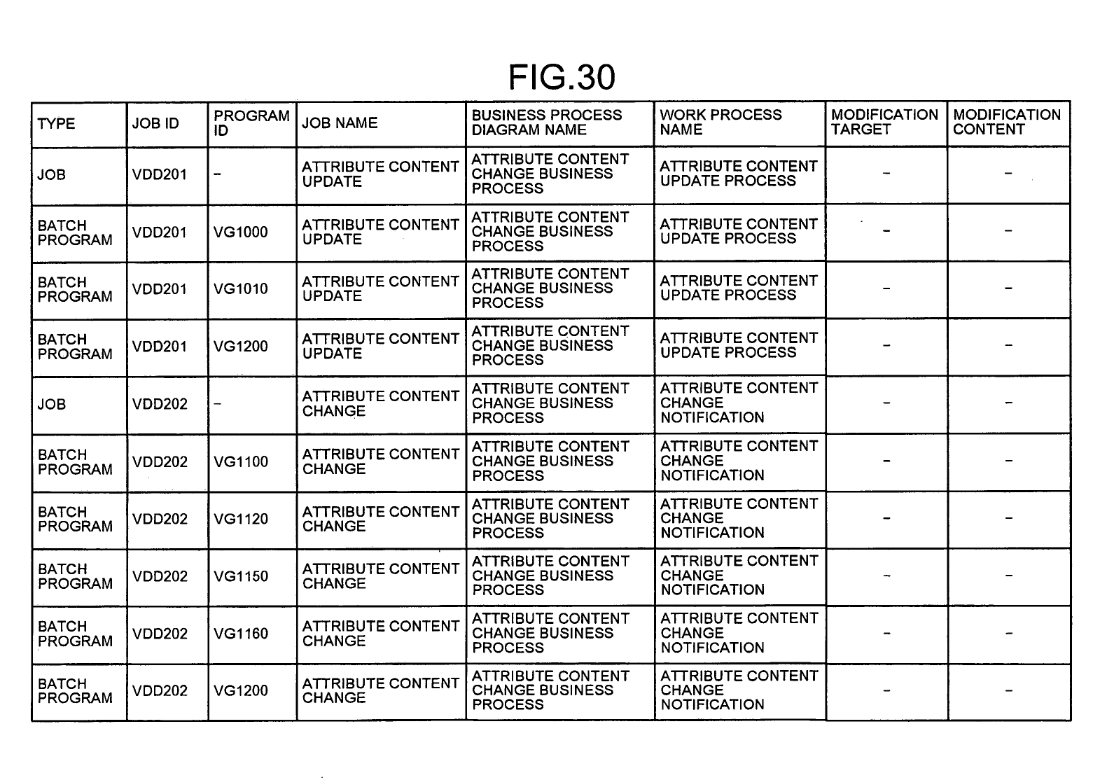

FIG. 30 is an example of the resource data 123. The resource data 123 includes items such as type, job ID, program ID, job name, business process diagram name, business process name, modification target, and modification content.

During an output of the job related data, the character string “job” is stored in the entry of type, the job ID is stored in the entry of job ID, the entry of program ID is not set, the job name is stored in the entry of job name, a name of the business process diagram that includes the business object having the set job ID etc. is stored in the entry of business process diagram name, and a name of the business object is stored in the entry of business process name.

During an output of the batch program related data, the character string “batch program” is stored in the entry of type, the job ID of the job that includes the batch program is stored in the entry of job ID, the program ID is stored in the entry of program ID, the job name of the job is stored in the entry of job name, the name of the business process diagram that includes the business object having the set job ID etc. is stored in the entry of business process diagram name, and the name of the business object is stored in the entry of business process name.

During the output of both the job related data and the batch program related data, the entries of modification target and modification content are output without any settings. The entry of modification target specifies whether to modify the job or the batch program. The entry of modification content sets the content of modification if the job or the batch program is to be modified. The affected process output unit 116 uses the entries of modification target and modification content.

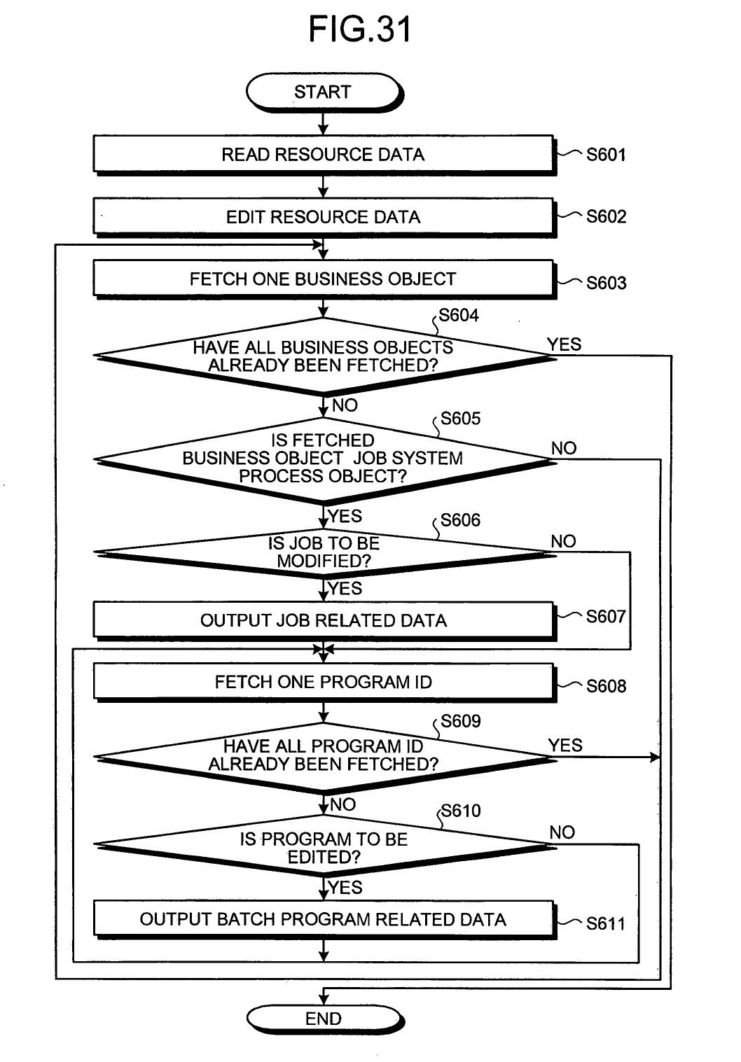

FIG. 31 is a flowchart of the operation of the affected process output unit 116. The affected process output unit 116 reads all the records of the resource data 123 (step S601), displays the contents of the read records in a modification select screen so that the user can select a job and a batch program to be modified, and records a result of the selection in the resource data 123 (step S602).

Next, the affected process output unit 116 fetches one business object (step S603). If all the business objects have already been fetched (Yes at step S604), the affected process output unit 116 ends the process.

Upon fetching the business object (No at step S604), the affected process output unit 116 confirms the class name of the business object of the fetched record. If the class name is not “job system process” (No at step S605), the process returns to step S603 and the affected process output unit 116 attempts to fetch the next business object.

If the class name is “job system process” (Yes at step S605), the affected process output unit 116 refers to the resource data 123. If the job corresponding to the job ID that is set in the business object is to be modified (Yes at step S606), the affected process output unit 116 outputs data of the job corresponding to the job ID (step S607). If the job is not to be modified (No at step S606), the affected process output unit 116 does not output the data of the job.

Next, the affected process output unit 116 fetches one program ID of the batch programs that are set in the business object (step S608). If all the program IDs have already been fetched (Yes at step S609), the process returns to step S603 and the affected process output unit 116 attempts to fetch the next business object.

Upon fetching the program ID (No at step S609), the affected process output unit 116 refers to the resource data 123. If the batch program corresponding to the fetched program ID is to be modified (Yes at step S610), after the affected process output unit 116 has output the data of the batch program corresponding to the program ID (step S611), the process returns to step S608 and the affected process output unit 116 attempts to fetch the next program ID. If the batch program is not to be modified (No at step S610), the affected process output unit 116 does not output the data of the batch program, the process moves to step S608, and the affected process output unit 116 attempts to fetch the next program ID.

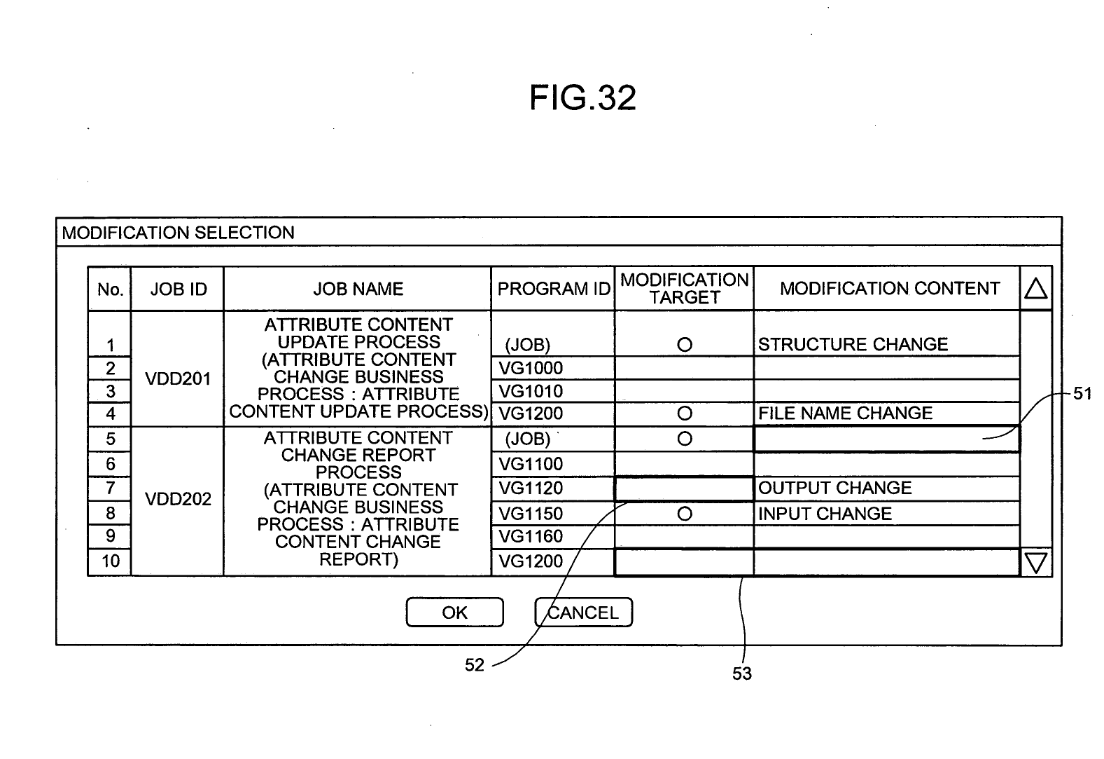

FIG. 32 an example of the modification select screen displayed at step S602 in FIG. 31. The modification select screen displays a list of the contents of the resource data 123 so that the user can edit the entries of modification target and modification content. The affected process output unit 116 checks an input content of the modification select screen to determine whether the modification select screen includes any inconsistency, and issues a warning if an inconsistency is detected.

For example, in the example shown in FIG. 32, modification content is not input for an input item 51 although a necessity of modification is specified in the corresponding input item of a modification target. Due to this, the affected process output unit 116 issues a warning related to the input item 51. Similarly, because the necessity of modification is not specified in an input item 52 although the modification content is input to the corresponding input item, the affected process output unit 116 issues a warning related to the input item 52. Further, because the necessity of modification is not specified in an input item 53 although the necessity of modification is specified for other records that include the same program ID, The affected process output unit 116 issues a warning related to the input item 53.

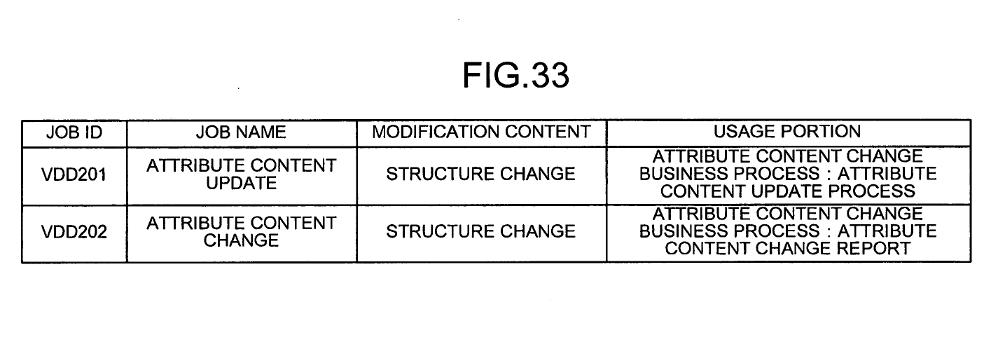

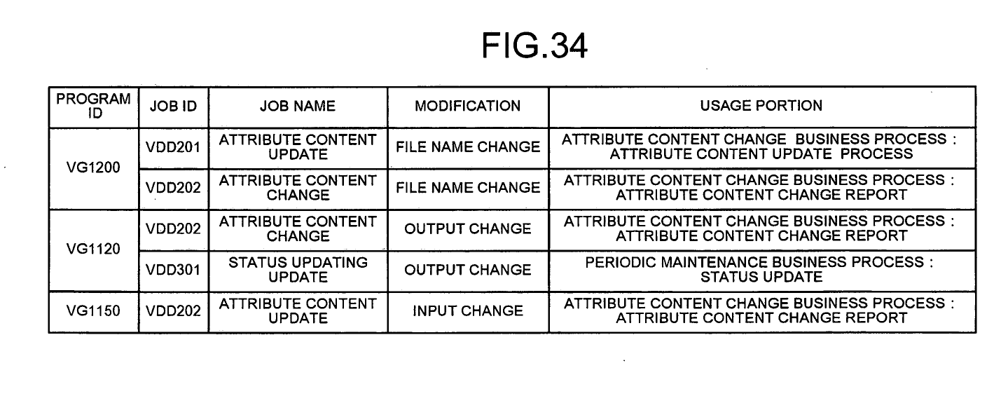

FIGS. 33 and 34 are examples of output of the affected process output unit 116. FIG. 33 is an example of output of data related to jobs that are affected by modification. The output data includes, with respect to each job, data such as job ID, job name, modification content input on the modification select screen, and data that indicates a location, in a business process diagram, of the business process corresponding to the business object that includes the set data related to the job.

FIG. 34 is an example of output of data related to batch programs that are affected by modification. The output data includes, with respect to each batch program, data such as program ID, job ID and job name of a job that includes the batch program, modification content input on the modification select screen, and data that indicates a location, in a business process diagram, of the business process corresponding to the business object that includes the set data related to the batch program.

By referring to the output from the tables shown in FIGS. 33 and 34, the user can confirm all the business processes that are executed by the jobs and the batch programs that are to be modified. For example, by referring to the output shown in FIG. 34, the user can confirm that the batch program with a program ID “VG1120” is executed by the business process in the business process diagram “attribute content change business process” and is also executed by the business process in the business process diagram “periodic maintenance business process”.

Further, various modifications can be made to the structure of the business process editor 100 without departing from the scope of the present invention. For example, a processor that analyzes an existing business system can also be included in the business process editor 100. Further, the controller 110 of the business process editor 100 can be implemented as software. In other words, a computer program (hereinafter, business process editing program) can be executed on a computer to realize the same function as the business process editor 100. In the following, such a computer which executes a business process editing program 1071 is explained.

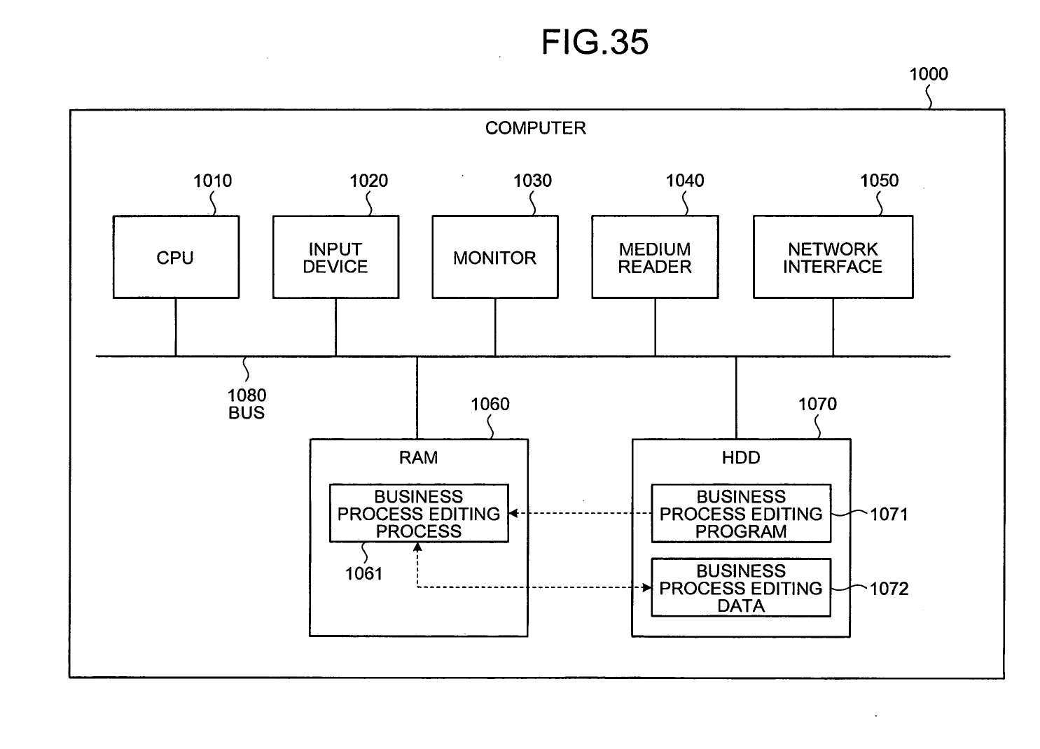

FIG. 35 is a functional block diagram of a computer 1000 that executes the business process editing program 1071. The computer 1000 includes a Central Processing Unit (CPU) 1010 that executes various calculation processes, an input device 1020 that receives an input of data from the user, a monitor 1030 that displays various types of data, a medium reader 1040 that reads programs etc. from a recording medium, a network interface 1050 that carries out transfer of data between the computer 1000 and another computer via a network, a Random Access Memory (RAM) 1060 that temporarily stores various types of data, and a Hard Disk Device (HDD) 1070 that are connected by buses 1080.

The HDD 1070 stores therein the business process editing program 1071 that includes similar functions as the functions of the controller 110 shown in FIG. 1 and business process editing data 1072 that corresponds to various types of data that are stored in the storage unit 120 shown in FIG. 1. The business process editing data 1072 can also be appropriately distributed and stored in another computer that is connected to the computer 1000 via the network.

The CPU 1010 reads the business process editing program 1071 from the HDD 1070 and expands the business process editing program 1071 to the RAM 1060, thus causing the business process editing program 1071 to function as a business process editing process 1061. The business process editing process 1061 expands data read from the business process editing data 1072 to an area allocated to itself in the RAM 1060, and executes various data processes based on the expanded data.

The business process editing program 1071 need not always be stored in the HDD 1070. The business process editing program 1071 stored in a storage medium such as a Compact Disk-Read Only Memory (CD-ROM) can be read by the computer 1000 and executed. The business process editing process 1071 can also be stored beforehand in another computer (or a server) that is connected to the computer 1000 via a public line, the Internet, a Local Area Network (LAN), a Wide Area Network (WAN) etc., read by the computer 1000 from the other computer (or the server), and executed.

In the embodiment, the business process editor 100 can read the analysis result of the existing business system to generate the business objects and use a simple operation to embed the generated business objects in the business process diagram. Thus, the user can easily edit the business process diagram that accurately reflects the content of the existing business system.

Moreover, from the data read by the business-system analysis-result reader 111, the business process editor 100 outputs the list of the data that is not reflected in the business process diagram. Thus, the user can avoid occurrence of a reflection omission when reflecting the content of the existing business system in the business process diagram.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for editing a business process diagram that represents a flow of business process including electronic processing performed by a business system, the computer program causing a computer to execute:
reading a result of analysis of specification of the electronic processing; and
editing a data structure that represents the business process diagram, in which a business object corresponding to a business process includes, among information read at the reading, information related to electronic processing performed in the business process.

2. The computer-readable recording medium according to claim 1, wherein the computer program further causing the computer to execute outputting, among the information read at the reading, information that is not included in any of business objects.

3. The computer-readable recording medium according to claim 2, wherein the outputting includes excluding previously specified information from the information to be output.

4. The computer-readable recording medium according to claim 1, wherein the computer program further causing the computer to execute outputting, among information included in a business object corresponding to a business process specified to be modified, information related to the electronic processing.

5. The computer-readable recording medium according to claim 1, wherein the computer program further causing the computer to execute referring to the information included in the business object to output information related to a business process in which electronic processing specified to be modified is performed.

6. A business process editor that edits a business process diagram that represent a flow of business process including electronic processing performed by a business system, the business process editor comprising:
a reading unit that reads a result of analysis of specification of the electronic processing; and
an editing unit that edits a data structure that represents the business process diagram, in which a business object corresponding to a business process includes, among information read by the reading unit, information related to electronic processing performed in the business process.

7. The business process editor according to claim 6, further comprising an unused-resource output unit that outputs, among the information read by the reading unit, information that is not included in any of business objects.

8. The business process editor according to claim 7, wherein the unused-resource output unit excludes previously specified information from the information to be output.

9. The business process editor according to claim 6, further comprising a target-resource output unit that outputs, among information included in a business object corresponding to a business process specified to be modified, information related to the electronic processing.

10. The business process editor according to claim 6, further comprising an affected process output unit that refers to the information included in the business object to output information related to a business process in which electronic processing specified to be modified is performed.

11. A business process editing method for electronically editing a business process diagram that represents a flow of business process including electronic processing performed by a business system, the business process editing method comprising:
reading a result of analysis of specification of the electronic processing; and
editing a data structure that represents the business process diagram, in which a business object corresponding to a business process includes, among information read at the reading, information related to electronic processing performed in the business process.

12. The computer-readable recording medium according to claim 11, further comprising outputting, among the information read at the reading, information that is not included in any of business objects.

13. The computer-readable recording medium according to claim 12, wherein the outputting includes excluding previously specified information from the information to be output.

14. The computer-readable recording medium according to claim 11, further comprising outputting, among information included in a business object corresponding to a business process specified to be modified, information related to the electronic processing.

15. The computer-readable recording medium according to claim 11, further comprising referring to the information included in the business object to output information related to a business process in which electronic processing specified to be modified is performed.
